(19) United States
(12) Patent Application Publication
(10) Pub. No.: US 2015/0058751 A1
(43) Pub. Date: Feb. 26, 2015

(54) Facepile Integrated Communications

(71) Applicant: Facebook, Inc., Menlo Park, CA (US)

(72) Inventor: Erick Tseng, San Francisco, CA (US)

(73) Assignee: Facebook, Inc., Menlo Park, CA (US)

(21) Appl. No.: 13/974,923

(22) Filed: Aug. 23, 2013

(51) Int. Cl. H04L 29/06

(52) U.S. Cl. CPC H04L 65/403
USPC 715/753

(57) ABSTRACT

In one embodiment, a method includes determining, from a social graph, a plurality of second users having a connection to a first user, providing a facepile for display on a display device of the first user, and providing a communications composer for display on the display device in response to a user-selection by the first user within the facepile. The facepile includes a plurality of visual indications of the plurality of second users having a connection to the first user and each visual indication is associated with one of the plurality of second users. The communications composer includes a user interface that provides communication between the first user and the plurality of second users associated with the visual indications displayed in the facepile.

### TECHNICAL FIELD

This disclosure generally relates to social networking and more specifically to providing facepile integrated communications.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

Particular embodiments enhance a user's media viewing experience by providing facepile integrated chat sessions which may be displayed, for example, on a mobile device, a personal computer, or any other display device. A facepile may be displayed, for example, on a platform show page for a particular show that is presented when the user selects an entry in a programming guide. The facepile includes images, avatars, or other representations of other users having a connection to the user (e.g., friends of the user). The facepile, or one or more user-selectable objects within the facepile, may be selected by the user to begin a chat session with the users displayed in the facepile. The facepile integrated chat session provides an enhanced user experience by providing the user with a quick and convenient way to begin a conversation with the user's friends who have liked the particular show or who are currently watching the particular show.

In certain embodiments, a chat composer is displayed to the user in response to the user selecting one or more objects within a facepile. For example, the user may select visual indications (e.g., avatars of the user's friends) within a facepile to begin a chat session with the selected users. As another example, the user may select a button to begin a chat session with all of the users displayed in the facepile. In some embodiments, an address field within the chat composer may be automatically pre-populated with either all of the users shown in the facepile or with the selected users. In some embodiments, a message field within the chat composer may be automatically pre-populated with text that relates to, for example, the particular show of the platform show page on which the facepile resides.

### BRIEF DESCRIPTION OF THE DRAWINGS

FIG. 1 illustrates an example network environment associated with a social-networking system, according to certain embodiments.

FIG. 2 illustrates an example social graph, according to certain embodiments.

FIG. 3 illustrates an example programming guide, according to certain embodiments.

FIG. 4 illustrates an example platform show page, according to certain embodiments.

FIG. 5 illustrates a communications composer, according to certain embodiments.

FIG. 6 illustrates an example method for providing facepile integrated communications, according to certain embodiments.

FIG. 7 illustrates an example computer system, according to certain embodiments.

### DESCRIPTION OF EXAMPLE EMBODIMENTS

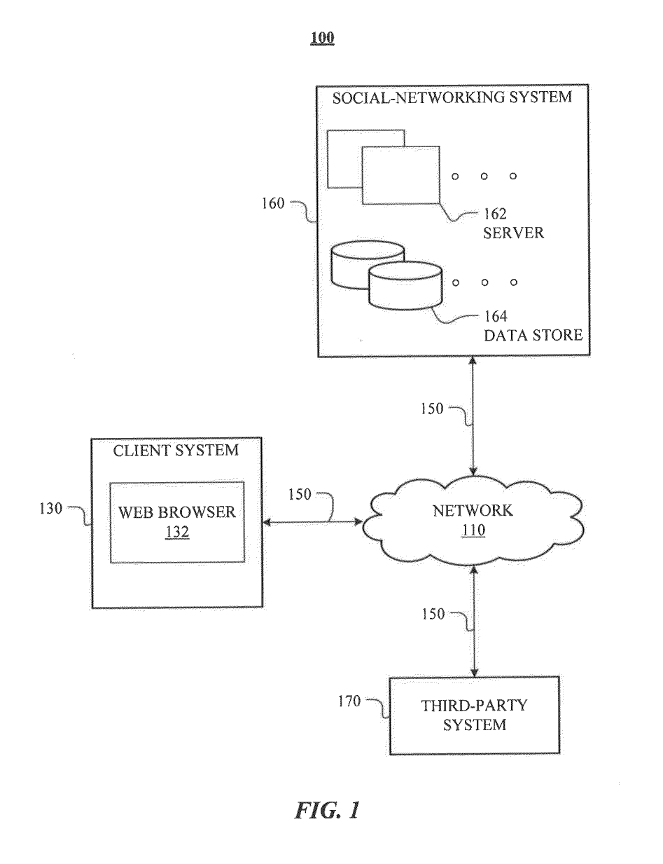

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. In some embodiments, client system 130 may alternately or additionally include a mobile application (“app”). A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 164 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g., relationships) to a number of other users of social-networking system 160 whom they want to be connected to. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in to or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

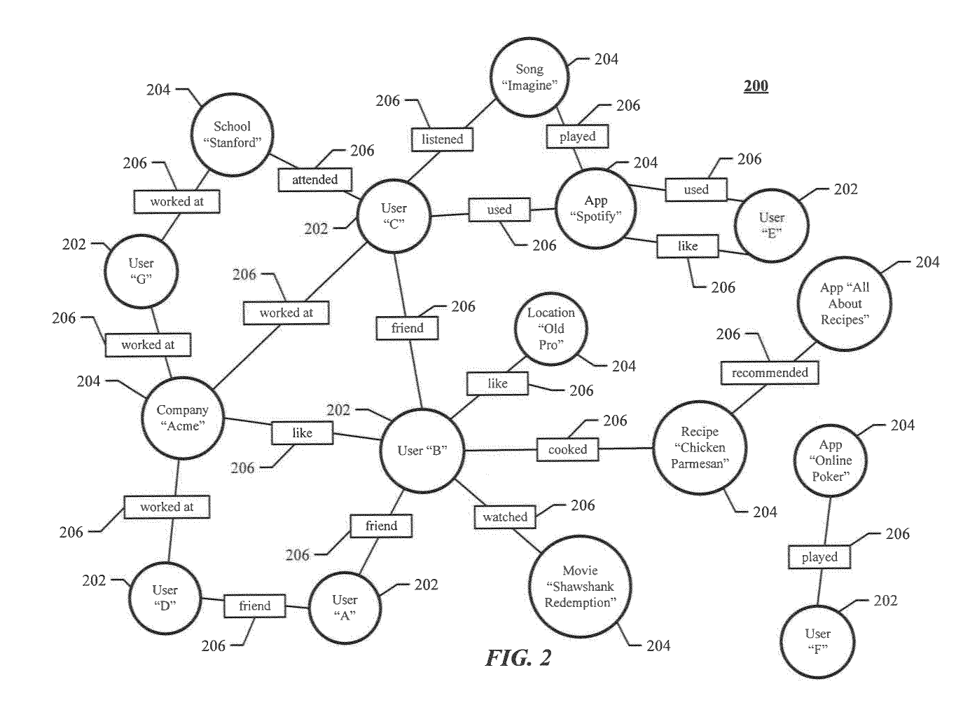

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 130 to send to social-networking system 160 a message indicating the user's action. In response to the message, social-networking system 160 may create an edge (e.g., an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 164. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 160). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 160 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 160) or RSVP (e.g., through social-networking system 160) to an event associated with the advertisement. In addition or as an alternative, an advertisement may include social-networking-system context directed to the user. As an example and not by way of limitation, an advertisement may display information about a friend of the user within social-networking system 160 who has taken an action associated with the subject matter of the advertisement.

In particular embodiments, social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 160 may calculate a coefficient based on a user's actions. Social-networking system 160 may monitor such actions on the online social network, on a third-party system 170, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social-networking system 160 may calculate a coefficient based on the user's actions with particular types of content. The content may be associated with the online social network, a third-party system 170, or another suitable system. The content may include users, profile pages, posts, news stories, headlines, instant messages, chat room conversations, emails, advertisements, pictures, video, music, other suitable objects, or any combination thereof. Social-networking system 160 may analyze a user's actions to determine whether one or more of the actions indicate an affinity for subject matter, content, other users, and so forth. As an example and not by way of limitation, if a user may make frequently posts content related to “coffee” or variants thereof, social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 160 may calculate a coefficient based on the type of relationship between particular objects. Referencing the social graph 200, social-networking system 160 may analyze the number and/or type of edges 206 connecting particular user nodes 202 and concept nodes 204 when calculating a coefficient. As an example and not by way of limitation, user nodes 202 that are connected by a spouse-type edge (representing that the two users are married) may be assigned a higher coefficient than a user nodes 202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 160 may determine that the user has a higher coefficient with respect to the first photo than the second photo because having a tagged-in-type relationship with content may be assigned a higher weight and/or rating than having a like-type relationship with content. In particular embodiments, social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 200. As an example and not by way of limitation, social-graph entities that are closer in the social graph 200 (i.e., fewer degrees of separation) may have a higher coefficient than entities that are further apart in the social graph 200.

In particular embodiments, social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, social-networking system 160 may determine that the user has a higher coefficient for the airport than the gas station based on the proximity of the airport to the user.

In particular embodiments, social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 160 may provide information that is relevant to user's interests and current circumstances, increasing the likelihood that they will find such information of interest. In particular embodiments, social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, social-networking system 160 may calculate the coefficient (or access the coefficient information if it has previously been calculated and stored). In particular embodiments, social-networking system 160 may measure an affinity with respect to a particular process. Different processes (both internal and external to the online social network) may request a coefficient for a particular object or set of objects. Social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

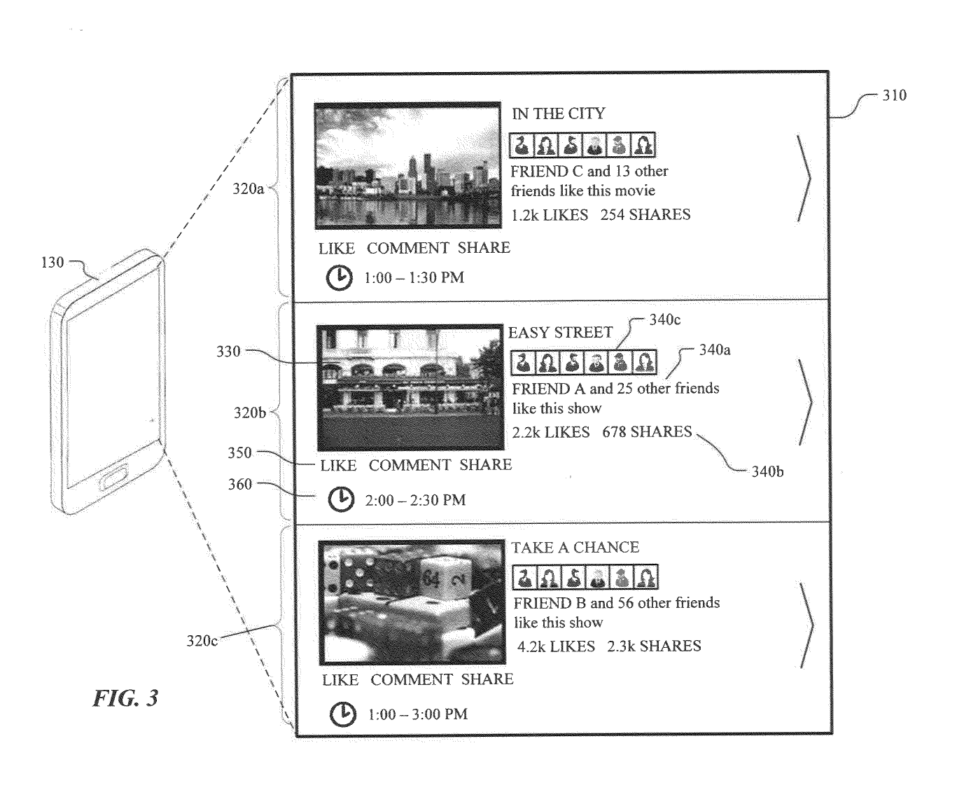

FIG. 3 illustrates an example programming guide 310 which may be displayed on mobile device 130 or any other client system 130. In some embodiments, programming guide 310 is generated by social-networking system 160 using social graph 200 and is a personalized set of available media content to display to a user. For example, programming guide 310 may include media content (e.g., shows) that is available to the user along with social content related to the user and the media content.

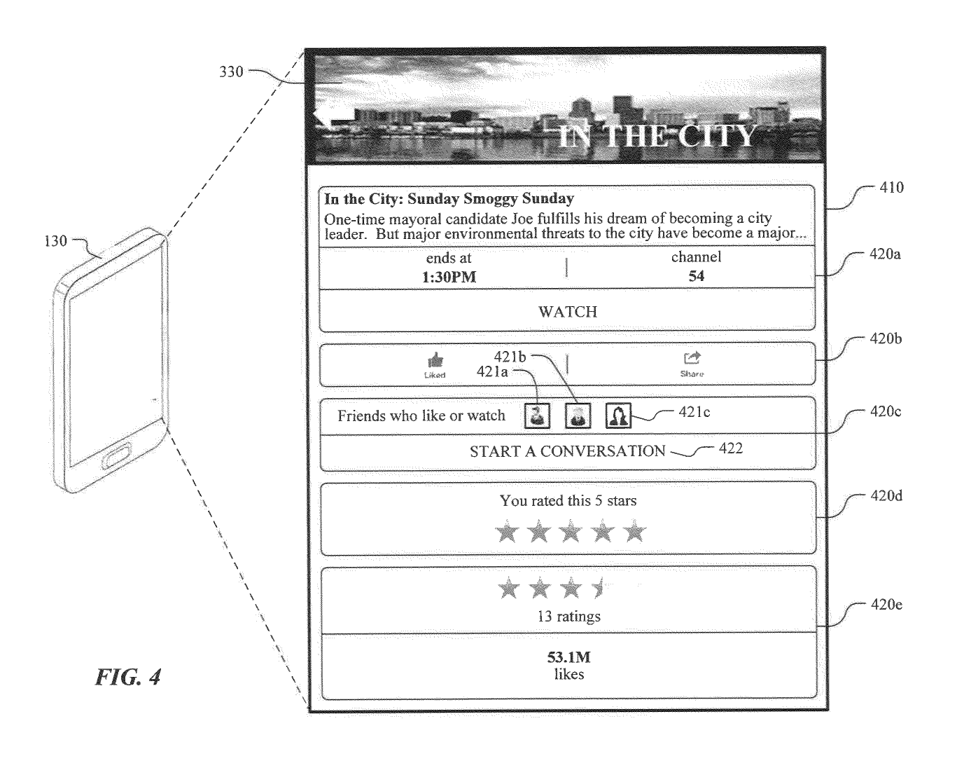

In general, programming guide 310 provides an easy and convenient way for a user to view and select available content to display on any client system 130. In some embodiments, programming guide 310 may aggregate content from multiple sources (e.g., over-the-top (OTT) content provider such as NetFlix, Hulu, Amazon Video, and YouTube, multiple system operators (MSO) such as Comcast, Time Warner, AT&T U-verse, and Dish Network, on-demand programming, DVRs, third-party internet sites, other cable provides, etc.) into a convenient list of available media content according to the user's interests. The user is not required to know where the content is being sourced from or what channel is associated with the content. Instead, the user may simply tap or otherwise select a programming guide entry 320 for a particular show and be presented with a show page 410 for the particular show as illustrated in FIG. 4 and described below. The user may then view information about the selected show and may select an option on show page 410 to begin watching the show. The show will then be displayed on any client system 130 such as the user's smart phone or a TV of the user.

Programming guide 310 may include any available content that may be viewed on any client system 130. For example, programming guide 310 may include content from MSOs that would typically be selected using a set-top box (STB). Programming guide 310 may also include content from an OTT provider such as Hulu and Netflix. Content in programming guide 310 may also be on-demand content and may include an indication of the price to view the on-demand content. In some embodiments, programming guide 310 may be displayed on mobile device 130 using, for example, a mobile app of social-networking system 160.

Programming guide 310 includes programming guide entries 320 (e.g., programming guide entries 320a-c in this example). Each programming guide entry 320 may include a media content image 330, social content 340, one or more user selectable options 350, and airing time 360. Social content 340 of each programming guide entry 320 is related to the media content of programming guide entry 320 and is generated by social-networking system 160 using social graph 200.

Media content image 330 may be any image or graphic associated with the media content of programming guide entry 320. In some embodiments, media content image 330 may be an image captured from video associated with the media of programming guide entry 320. For example, media content image 330a may be an image captured from the TV show “In the City” of programming guide entry 320a. In some embodiments, media content image 330 may be a cover image provided by an entity associated with the media content of programming guide entry 320. For example, if a particular movie studio produced the movie “Take a Chance” of programming guide entry 320c, the movie studio may provide or otherwise indicate to social-networking system 160 a particular image to use as a cover image for the movie. Social-networking system 160 may then access the cover image and use it as media content image 330 to represent the movie in programming guide 310.

Social content 340 is any social content associated with the media content of programming guide entry 320 that is determined by social-networking system 160 from social graph 200. In some embodiments, social content 340 may include an indication of how many other users of social-networking system 160 have viewed, “liked,” shared, or posted comments about the media content of programming guide entry 320. As a specific example, consider the example programming guide entry 320b of FIG. 3. In this example, the media content of programming guide entry 320b is a TV show called “Easy Street.” Social-networking system 160 may query social graph 200 and determine that twenty six of the user's friends have “liked” the TV show “Easy Street.” Social content 340a of programming guide entry 320b, which reads “FRIEND A and 25 other friends like this show” may then be generated and displayed proximate to media content image 330b for “Easy Street.” In another example, social-networking system 160 may query social graph 200 and determine that over 2,200 other users have “liked” “Easy Street” and that 678 other users have shared “Easy Street.” Social content 340b, which reads “2.2 k LIKES 678 SHARES” may then be generated and displayed proximate to media content image 330b for “Easy Street.” In some embodiments, social content 340 may also include a facepile 340c. Facepile 340c may include, for example, images, icons, or avatars of other users (e.g., friends) of social-networking system 160 who have liked the media content of programming guide entry 320, as determined using social graph 200.

User-selectable options 350 are any options that permit a user to perform one or more actions associated with programming guide entry 320. For example, user-selectable options 350 may include options that the user may select to indicate that he “likes” the media content of programming guide entry 320, to comment about the media content of programming guide entry 320, and to share the media content of programming guide entry 320. Once selected, user selectable-options 350 may cause any appropriate action within social-networking system 160. For example, if a user selects user selectable-option 350 to “like” the media content of programming guide entry 320b (i.e., “Easy Street”), an edge 206 may be added to social graph 200 to indicate that the user “likes” “Easy Street.” As another example, if a user selects user selectable-option 350 to “share” “Easy Street,” a post may appear in the user's friends' newsfeed indicating that the user has shared “Easy Street.”

In some embodiments, user selectable options 350 may include other options such as remind and record. For example, “REMIND” may be included as a user selectable option 350 in programming guide entry 320 and may cause, once selected by a user, a notification to be sent to the user when the media content of programming guide entry 320 is about to begin. As another example, “RECORD” may be included as a user selectable option 350 in programming guide entry 320 and may cause, once selected by a user, instructions to be sent to another device such as a DVR to record the media content of programming guide entry 320. In some embodiments, a primary action may also be established for each programming guide entry 320 (e.g., watch again, watch, record, etc.) using user selectable options 350.

Airing time 360 is any indication of the times in which the media content of programming guide entry 320 may be viewed. For example, airing time 360 of programming guide entry 320a indicates that the movie “In the City” will begin at 1:00 PM and end at 3:00 PM. As another example, airing time 360 of programming guide entry 320b indicates that the TV show “Easy Street” will begin at 2:00 PM and end at 2:30 PM.

In operation, social-networking system 160 determines available media content from one or more content sources in order to provide programming guide 310. For example, social-networking system 160 may query MSOs, OTTs, or other cable providers to determine media content that is available for a particular user who is in a particular region. In certain embodiments, social-networking system 160 may determine a user's subscription info (e.g., which cable package he is subscribed to) in order to determine available media content for programming guide 310. For example, if the user is subscribed to basic cable from a certain cable provider in a certain city, social-networking system 160 may access a database of known channels and programs for the particular cable provider and city. Social-networking system 160 may then provide the available media content for display in client system 130. In certain embodiments, programming guide 310 displays what is currently on (i.e., what TV shows and movies are currently available to view) as well as TV shows and movies that are coming on soon (e.g., within the half hour, hour, day, week, etc.).

In some embodiments, social-networking system 160 may determine what cable package a user is currently subscribed to by pulling a list of all available packages from a MSO (e.g., basic cable, plus, premium, etc.) using an API and then use a setup wizard questionnaire to determine the user's current subscription. For example, the wizard may ask the user “do you get HBO?” Based on the user's answer, social-networking system 160 may utilize any appropriate logic to determine the user's subscription. For example, if the user answers that he does not get HBO and the list of available packages from the MSO indicates that HBO is available on all packages except for the basic package, social-networking system 160 may determine that the user has basic cable. In some embodiments, if the user indicates that he does not get HBO, social-networking system 160 may determine a list of other channels that the user likely does not get and prompt the user: “We don't think you get these channels either. Do you get these?”

In some embodiments, the media content of programming guide 310 is recommended media content for the user that is determined by social-networking system 160. In general, the recommended media content may be determined based on interests and social context using information from social graph 200. To do so, social-networking system 160 queries social graph 200 for information associated with one or more users of the social-networking system. Once the information from social graph 200 is obtained, social-networking system 160 utilizes the information to determine recommended media content for the user. Determining the recommended media content is discussed in more detail below.

In certain embodiments, social networking system 160 may utilize social coefficients to determine recommended media content for programming guide 310. Some embodiments may utilize coefficients as described in U.S. patent application Ser. No. 12/978,265 entitled “Contextually Relevant Affinity Prediction in a Social Networking System,” which is incorporated herein by reference. Social networking system 160 may utilize the following information from social graph 200 in determining coefficients of specific media content for an individual user:
the number of friends of the user who have liked the specific media content
the total number of users of social networking system 160 who have liked the specific media content
the number of friends of the user who have viewed the specific media content
the total number of users of social networking system 160 who have viewed the specific media content
a taste algorithm (e.g., users who liked the specific content will also like this other content.)
   Social networking system 160 may then combine the information above in order to determine a coefficient associated with the user for each content. For example, consider a scenario in which a query of social graph 200 for a specific media content yielded the following results:
the number of friends of the user who have liked the specific media content=5
the total number of users of social networking system 160 who have liked the specific media content=1000
the number of friends of the user who have viewed the specific media content=2
the total number of users of social networking system 160 who have viewed the specific media content=250
   The combination of these example results would yield a coefficient of 5+1000+24250=1257 for this specific media content for the user. Social networking system 160 then performs similar calculations in order to determine coefficients of other media content for the user. In certain embodiments, the resulting coefficients of all media content are then ranked for the user. A predetermined number of the top-ranked media content may then be presented to the user as recommended media content in programming guide 310.

As discussed above, a taste algorithm may be utilized by social networking system 160 to determine recommended media content for the user. For example, social networking system 160 may first determine first media content that a user watched, liked, or otherwise interacted with on social networking system 160. In some embodiments, the first media content may be determined using social graph 200. Once the first media content has been determined, social networking system 160 may then search social graph 200 to determine other users or friends of the user who also watched, liked, or otherwise interacted with the first media content on social networking system 160. Social networking system 160 may then search social graph 200 for second media content that the determined users or friends watched, liked, or otherwise interacted with on social networking system 160. The determined second media content may then be recommended to the user as recommended media content in programming guide 310. In some embodiments, weighting factors may be utilized in determining what media content to recommend to a user. For example, second media content viewed by a user's friends may have a higher weight in determining recommendations for a user than second media content viewed by users who are not friends.

As an example for illustrative purposes only, consider a scenario where a first user has liked the media content “Garage Talk” in the past. Social networking system 160 may query social graph 200 in order to determine other users or friends of the first user who have also liked “Garage Talk.” For example, social networking system 160 may determine that Friend A and User B also liked “Garage Talk.” Social networking system 160 may then query social graph 200 for other media content liked by the other users or friends who also liked “Garage Talk.” For example, social networking system 160 may determine that Friend A and User B, who liked “Garage Talk,” also liked “Shop Journal” and “Cars Galore.” Social networking system 160 may then display “Shop Journal” and “Cars Galore” as recommended media content to the first user in programming guide 310. If, for example, Friend A liked “Shop Journal” and User B (who is not a friend of the first user) liked “Cars Galore,” then “Shop Journal” may appear higher in programming guide 310 than “Shop Journal.”

In certain embodiments, social networking system 160 may determine trending media content or their associated media content to display as recommended media content in programming guide 310. For example, social networking system 160 may analyze posts, likes, or any other interaction with social networking system 160 in order to determine media content that is trending. Media content that is trending may be, for example, content that has received the most “likes” or views within a predetermined period. Social networking system 160 may then include one or more trending media content as recommended media content in programming guide 310.

One programming guide 310 is displayed on client system 130, a user has the option to select any programming guide entry 320 in order to view more information about the media content of the selected programming guide entry 320. For example, the user may touch, tap, or otherwise select programming guide 310a for the TV show “In the City” in order to view more information about “In the City.” Once a programming guide entry 320 is selected, a show page 410 will be displayed on client system 130. For example, if the user selects programming guide entry 320a, a show page 410 for “In the City” will be presented to the user on client system 130. A particular embodiment of a show page 410 is described in more detail below in reference to FIG. 4.

FIG. 4 illustrates an example show page 410 which may be displayed in response to a user selecting a programming guide entry 320 of programming guide 310. In general, show page 410 includes information and user-selectable options for a show of a selected programming guide entry 320. In this example, show page 410 is for the TV show “In the City” and is presented in response to the user selecting programming guide entry 320a. In other embodiments, show page 410 may be for any other media content such as movies, sporting events, video games, and the like. Show page 410 may include media content image 330 and one or more modules 420 as described in more detail below. The information and user-selectable options about the particular show are generally presented using modules 420. As described further below, social-networking system 160 determines which modules 420 to include on show page 410. In addition, social-networking system 160 may determine in some embodiments an order in which to present modules 420 on show page 410.

Module 420 is any portion or region of show page 410 that is dedicated to a specific purpose related to a particular show. For example, module 420 may be an area to present information about the particular show to the user (e.g., show start/end times, channel, etc.). As another example, module 420 may be an area that allows the user to select one or more options related to the particular show (e.g., to watch the particular show, to rate the particular show, etc.). Specific examples of modules 420 are discussed below.

) Module 420a is an airings module that presents basic information about the selected show and provides the user with an option to begin watching the show. For example, some embodiments of airings module 420a include a time associated with the particular show (e.g., a start and/or end time), a description of the particular show, a channel number of the particular show, and a user-selectable option to watch the particular show, as illustrated. The description of the show may include a general description of the show series, a description of the particular episode of the show, or any other appropriate description. The user-selectable option to watch the particular program may send instructions to begin playing the particular show on any client system 130 of the user or may send instructions to tune another client system 130 to a channel in which the particular show may be viewed. In some embodiments, airings module 420a may be displayed for every programming guide entry 320 and is immediately below media content image 330 (i.e., is the first module 420 on show page 410).

Module 420b is an action bar module that provides one or more user-selectable options (e.g., buttons) that allows the user to submit information to social-networking system 160 about the particular show. For example, some embodiments of action bar module 420b include a “like” button that allows the user to indicate to social-networking system 160 that he likes the particular show. As another example, some embodiments of action bar module 420b include a “share” button that allows the user to share the particular show with other users of social-networking system 160. In some embodiments, one or more edges 206 may be generated in social graph 200 between a user node 202 of the user and one or more other concept nodes 204 in social graph 200 related to the particular show when a user selects a user-selectable option in action bar module 420b. For example, a “like” edge 206 may be generated in social graph 200 between the user node 202 of the user and a concept node 204 for “In the City” when the user selects a button within action bar module 420b to “like” the show “In the City.” In some embodiments, action bar module 420b may display an icon that the user has previously “liked” the show “In the City” if social-networking system 160 determines there is already an edge 206 in social graph 200 between user node 202 of the user and concept node 204 for “In the City.”

Module 420c is a facepile module that includes visual indications 421 of other users of the social-networking system that have a connection to the user as determined by social graph 200. In some embodiments, visual indications 421 are associated with friends of the user who have liked or viewed the particular show. In some embodiments, facepile module 420c includes a user-selectable button 422 that, once selected, presents a communications composer 510 (described below) that permits the user to communicate (e.g., chat) with the indicated users in the facepile.

Visual indications 421 may be any image, icon, avatar, graphic, etc. that represents any other user (e.g., friend) of social-networking system 160. For example, visual indication 421a may represent User A of social-networking system 160, visual indication 421b may represent User B of social-networking system 160, and visual indication 421c may represent User C of social-networking system 160. In some embodiments, each visual indication 421 is associated with one or more user nodes 202 of social graph 200. In some embodiments, each visual indication 421 is selectable by the user either individually or as a group of visual indications 421. In some embodiments, once one or more visual indications 421 are selected by the user, communications composer 510 is presented to the user in order to allow the user to communicate (e.g., chat) with the selected users. In some embodiments, visual indications 421 are the interactive elements (e.g., interactive elements 510) as described in U.S. patent application Ser. No. 13/685,431, which is incorporated herein by reference.

In particular embodiments, the visual indications 421 displayed to a user in facepile module 420c may be determined based on a ranking of social graph nodes associated with the user in social graph 200. This ranking may, in particular embodiments, be determined based on a calculated coefficient, as described above. For example, the coefficient of each of the social graph nodes associated with the user may be calculated and the nodes ranked based on these calculated coefficients. The visual indications 421 corresponding to the top N social graph nodes in a ranking may be displayed to the user. As an example, visual indications 421 corresponding to the top N (e.g., five) friends of the user may be displayed in the facepile. Additionally, the arrangement (e.g., ordering, location on the screen, etc.) of visual indications 421 may depend on the ranking of the social graph nodes corresponding to the visual indications 421 (e.g., the highest-ranked visual indications 421 being first in the facepile, etc.).

Module 420d is a ratings module that provides a user-selectable option to rate the particular show. For example, ratings module 420d may include a visual indication of a scale (e.g., numbers, stars, etc.) that allows the user to rate the particular show on the scale (e.g., 4 out of 5 stars, etc.). Or, if the user has previously rated the particular show, ratings module 420d may include an indication of the previous rating of the particular show by the user. The user ratings may be transmitted by ratings module 420d or show page 410 to social-networking system 160 where they may be stored and compiled for future use.

Module 420e is a reviews module that provides an indication of a compiled rating of the particular show by other users of social-networking system 160. For example, if all other users of social-networking system 160 have given the particular show an average rating of 3.5 out of 5 stars, reviews module 420e may provide an indication as illustrated in FIG. 4. In some embodiments, reviews module 420e may provide an indication of how many likes, comments, or shares the particular show has received from all other users of social-networking system 160 as determined from social graph 200.

In some embodiments, modules 420 may include a chat module that provides an interface for the user to chat with other users of social-networking system 160. For example, the user may select the chat module 420 (or a button in chat module 420) to start a chat session with other users of social-networking system 160. The chat session may appear in show page 410 or may be presented in a new interface on client system 130.

In some embodiments, modules 420 may include a voting module that provides an interface for the user to vote for particular content related to the particular show. For example, consider a scenario in which the selected show is a competition show such as a singing competition. In this scenario, show page 410 may include voting module 420 that allows the user to vote for contestants on the singing competition. The user's votes may be transmitted by voting module 420 or show page 410 to social-networking system 160 where they may be recorded and provided to a third party such as the producer of the singing competition.

In some embodiments, modules 420 may include an advertisement module that includes one or more displayed advertisements. For example, advertisement module 420 may include one or more advertisements for products related to the selected show. In another example, advertisement module 420 may include one or more advertisements that were purchased to run during the particular show or to be shown to users who view show page 410 for the particular show. In some embodiments, advertisement module 420 may be selectable by the user. In such embodiments, the user may be taken to, for example, a website or app associated with the advertised product when the user selects advertisement module 420 or a user-selectable option within advertisement module 420.

In some embodiments, modules 420 may include a sports module that includes sporting information that is associated with the particular show. For example, if the selected show is a sporting event, sports module 420 may appear in show page 410 and may include real-time scores for the sporting event. In some embodiments, sports module 420 may include fantasy sports information associated with the selected sporting event. In some embodiments, sports module 420 may be updated in real-time. While particular sporting information has been described, sports module 420 may include any information associated with a selected sporting event (e.g., Olympic medal counts, information for an upcoming game, etc.).

In operation, social-networking system 160 receives a selection by the user of a particular programming guide entry 320 for a particular show in programming guide 310. For example, once the user selects programming guide entry 320a for “In the City,” social-networking system 160 receives an indication of the selection of “In the City.” In response, show page 410 for “In the City” is provided by social-networking system 160 for display to the user. The provided show page 410 includes modules 420 as determined by social-networking system 160 as discussed below.

The modules 420 that are included in a displayed show page 410 are determined by social-networking system 160 using any appropriate algorithm or method. In some embodiments, social-networking system 160 may utilize a classification of the selected show to determine which modules 420 to display on show page 410. As one example, if the selected show is a sporting event such as a baseball game, social-networking system 160 may determine that sports module 420 should be displayed on show page 410 for the sporting event. As another example, if the selected show is a singing competition, social-networking system 160 may determine that voting module 420 should be displayed on show page 410 for the singing competition.

In some embodiments, certain modules 420 may be displayed for any selected programming guide entry 320. For example, certain embodiments may always display airings module 420a in order to provide information about the selected show and to provide the user a user-selectable option to being watching the show. As another example, certain embodiments may always display reviews module 420e to provide the user with an idea of how other people (e.g., the user's friends) within social-networking system 160 rate the particular show. In some embodiments, an advertisement module 420 may be displayed for any selected programming guide entry 320.

In some embodiments, social-networking system 160 may determine an order in which to display the determined modules 420 on show page 410. For example, if none of the user's friends are currently watching the selected program, facepile module 420c may be moved towards the bottom of show page 410. As another example, if the selected show is a sporting event, sports module 420 may be moved higher up on show page 410. The disclosure anticipates utilizing any appropriate algorithm or method for determining an order of modules 420 on show page 410.

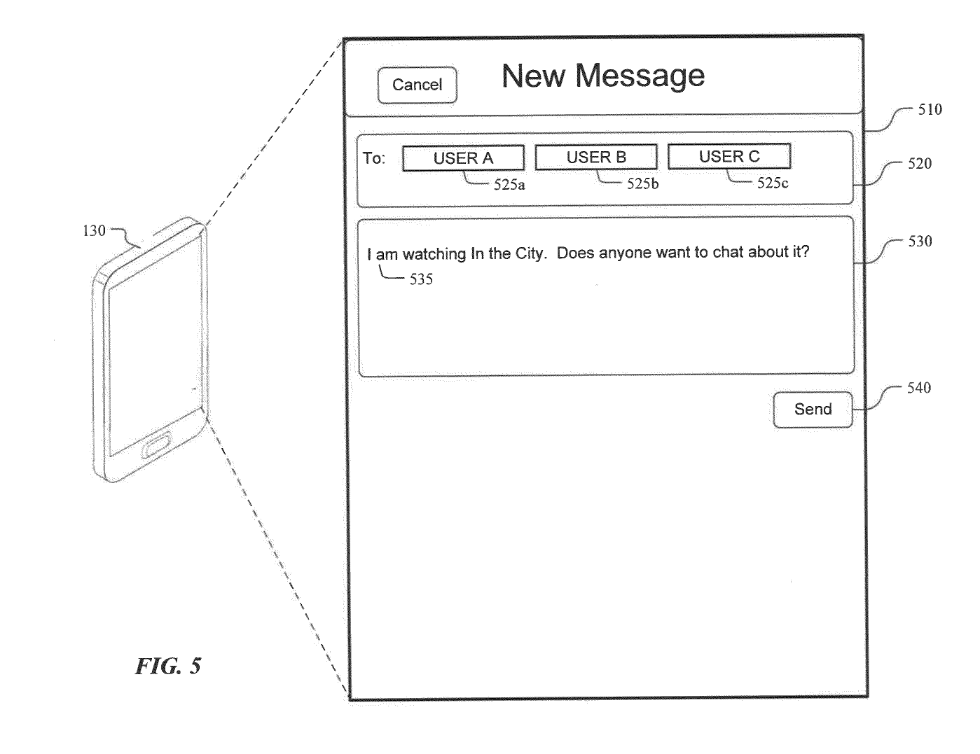

FIG. 5 illustrates an example communications composer 510 that may be presented on client system 130 in response to a user selection. For example, communications composer 510 may be displayed to the user on client system 130 when the user selects user-selectable button 422 in facepile module 420c. As another example, communications composer 510 may be displayed to the user on client system 130 when the user selects one or more visual indications 421 in a facepile such as facepile module 420c. In general, communications composer 510 permits the user to communicate with some or all of the users of social-networking system 160 that are indicated in the facepile. Communications composer 510 may permit the users of social-networking system 160 to communicate using an instant messaging (IM) session, an e-mail, Short Message Service (SMS) messaging, and the like.

Communications composer 510 includes an address field 520, a message field 530, and a send button 540. Address field 520 provides an interface for the user to enter the names of one or more other users of social-networking system 160 that the user wishes to communicate with. In some embodiments, the user may simply type the names of other users into address field 520. In some embodiments, the user may be presented with a list of recommended users to add to address field 520. For example, a list of users as determined using coefficients from social graph 200, as described above, may be presented to the user. The user may then select one or more of the recommended users to add to address field 520. In some embodiments, the recommended users include friends of the user who have liked the particular show of show page 410 on which facepile 420c resides. In some embodiments, the recommended users include friends of the user who are currently watching the particular show of show page 410 on which facepile 420c resides.

In some embodiments, address field 520 is automatically pre-populated with users from a facepile. For example, address field 520 may include pre-populated users 525 as illustrated in FIG. 5. In this example, pre-populated users 525 are the users associated with visual indications 421a-c in facepile module 420c of FIG. 4. Pre-populated users 525 may automatically appear in address field 520 when the user selects a user-selectable option in a facepile such as facepile module 420c. For example, if the user selects user-selectable button 422 to “Start a Conversation,” address field 520 may be automatically pre-populated with all of the users whose visual indications 421 appear in the facepile. In this example, since visual indications 421a-c are displayed in facepile module 420c, and visual indications 421a-c correspond to Users A-C, respectively, address field 520 may be pre-populated with Users A-C (i.e., pre-populated users 525a-c) in response to the user selecting user-selectable button 422. As another example, if the user selects one or more visual indications 421 (e.g., visual indications 421a and 421b) in facepile module 420c, address field 520 may be pre-populated with the selected users (e.g., Users A and B). The user may then review the pre-populated users in address field 520 and edit the users listed in address field 520 as desired (e.g., remove or add one or more users). As a result, the user in certain embodiments may quickly and easily start a conversation with one or more of his friends who have liked or are currently watching the particular show of show page 410.

Message field 530 provides an interface that allows the user to type a message to the users of address field 520. In some embodiments, message field 530 is pre-populated with text relating to content associated with the facepile. For example, if communications composer 510 is launched from a facepile that resides on a show page 410, message field 530 may include pre-populated text 535 that is associated with the particular show of the show page 410. For illustrative purposes only, consider the scenario of FIGS. 4 and 5. In the illustrated embodiments of these figures, facepile 420c resides on show page 410 for the show “In the City.” If the user selects user-selectable button 422 or one or more visual indications 421, communications composer 510 will appear and message field 530 may be pre-populated with text related to “In the City.” For example, pre-populated text 535 may be “I am watching In the City. Does anyone want to chat about it?” As a result, the user may quickly and easily start a conversation about “In the City” with his friends who have liked “In the City” or who are currently watching “In the City.”

In operation, communications composer 510 is displayed on client system 130 in response to a user-selection associated with a facepile. In some embodiments, communications composer 510 is displayed in response to a user selecting an option within a facepile to start a conversation with all of the users shown in the facepile. For example, communications composer 510 may be displayed in response to a user pressing user-selectable button 422 within facepile module 420c and may provide an interface for the user to start a conversation (e.g, via an IM session, SMS, email, etc.) with all of the users associated with visual indications 421 of the facepile. In some embodiments, communications composer 510 is displayed in response to a user selecting visual indications 421 within a facepile to start a conversation with all of the selected users. For example, communications composer 510 may be displayed in response to a user selecting one or more visual indications 421 within facepile module 420c and may provide an interface for the user to start a conversation with all of the selected users.

Once displayed, communications composer 510 provides address field 520 for the user to enter the names of the users in which he wishes to communicate and message field 530 for the user to enter text to send to the users listed in address field 520. As described above, address field 520 may be pre-populated with pre-populated users 525. In some embodiments, pre-populated users 525 may be all the users that were shown in the facepile (e.g., all the users associated with visual indications 421 of the facepile). In some embodiments, pre-populated users 525 may be the users associated with the selected visual indications 421 of the facepile. In certain embodiments, message field 530 may be pre-populated with text related to content associated with the facepile. For example, message field 530 may include pre-populated text 535, as described above. Once the user enters information into address field 520 and message field 530, the user may select send button 540 in order to send the message of message field 530 to the users listed in address field 520.

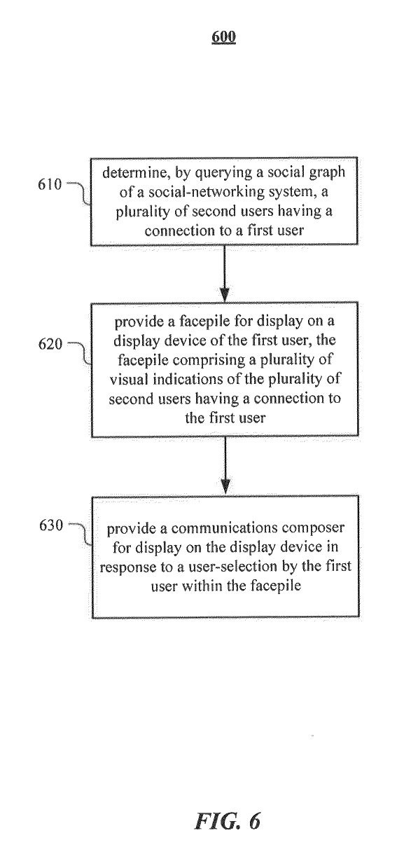

FIG. 6 illustrates an example method 600 for providing facepile integrated communications. The method may begin at step 610, where a plurality of second users having a connection to a first user are determined by querying a social graph of a social-networking system. In some embodiments, the plurality of second users are friends of the first user. In some embodiments, the social graph is social graph 200 and includes a plurality of nodes and edges connecting the nodes. Some of the nodes of the social graph are user nodes that are each associated with a particular user of the social-networking system. In some embodiments, the second users are determined by ranking, with respect to the first user, one or more nodes of the social graph and then selecting a plurality of nodes of the social graph based at least in part on the ranking.

In step 620, a facepile is provided for display on a display device of the first user. The facepile includes a plurality of visual indications of the plurality of second users of step 610. In some embodiments, each visual indication is associated with one of the plurality of second users. In some embodiments, the facepile is presented in a module such as facepile module 420c above. In some embodiments, the visual indications are visual indications 421 discussed above. In some embodiments, the display device is any client system 130 such as a smart phone.

In step 630, a communications composer is provided for display on the display device in response to a user-selection by the first user within the facepile of step 620. The communications composer provides a user interface in which the first user may communicate with the plurality of second users associated with the visual indications displayed in the facepile. In some embodiments, the communications composer of step 630 is communications composer 510. In some embodiments, the communications composer includes an address field such as address field 520 and a message field such as message field 530. In some embodiments, the address field is pre-populated with the plurality of second users associated with the visual indications displayed in the facepile. In some embodiments, the message field is pre-populated with text relating to content associated with the facepile. In certain embodiments, the communications provided by the communications composer may be an IM session, an e-mail, or an SMS message.

In some embodiments, each visual indication of the facepile of step 620 is selectable by the first user. In such embodiments, the user-selection by the first user within the facepile of step 640 is a selection by the first user of one or more of the visual indications in the facepile. In addition, the communications composer provides communication between the first user and the plurality of second users associated with the selected visual indications of the facepile.

In some embodiments, the user-selection by the first user within the facepile of step 620 includes selecting a user-selectable option to start communicating with the plurality of second users associated with all of the visual indications displayed in the facepile. In some embodiments, the user-selectable option is user-selectable button 422 discussed above. In such embodiments, the communications composer provides communication between the first user and the plurality of second users associated with all of the visual indications displayed in the facepile.

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

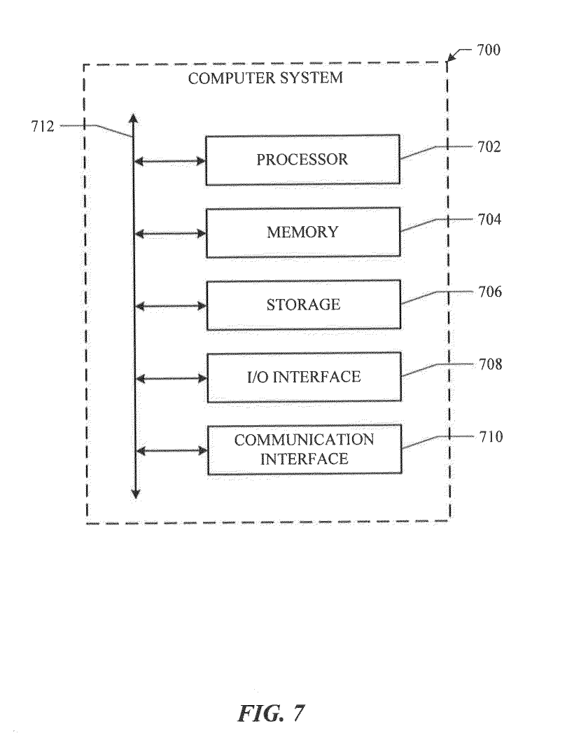

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments. I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular 1/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, “show” is inclusive of any appropriate media content. For example, “show” may refer to a TV show, a movie, a video game, or any other media content. “Show’ is utilized herein for simplicity and is not intended to refer to only TV shows.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by one or more computer systems of a social-networking system, determining, by querying a social graph of the social-networking system, a plurality of second users having a connection to a first user, the social graph comprising a plurality of nodes and edges connecting the nodes, the nodes comprising user nodes that are each associated with a particular user of the social-networking system;
by the one or more computer systems of the social-networking system, providing a facepile for display on a display device of the first user, the facepile comprising a plurality of visual indications of the plurality of second users having a connection to the first user, each visual indication associated with one of the plurality of second users; and
by the one or more computer systems of the social-networking system, providing a communications composer for display on the display device in response to a user-selection by the first user within the facepile, the communications composer comprising a user interface operable to provide communication between the first user and the plurality of second users associated with the visual indications displayed in the facepile.

2. The method of claim 1, wherein the communications composer comprises an address field that is pre-populated with the plurality of second users associated with the visual indications displayed in the facepile.

3. The method of claim 1, wherein the communications composer comprises a message field that is pre-populated with text relating to content associated with the facepile.

4. The method of claim 1, wherein determining, by querying the social graph of the social-networking system, the plurality of second users having a connection to the first user comprises:
ranking, with respect to the first user, one or more nodes of the social graph; and
selecting a plurality of nodes of the social graph based at least in part on the ranking.

5. The method of claim 1, wherein:
each visual indication of the facepile is selectable by the first user;
the user-selection by the first user within the facepile comprises a selection by the first user of one or more of the visual indications in the facepile; and
the communications composer provides communication between the first user and the plurality of second users associated with the selected visual indications of the facepile.

6. The method of claim 1, wherein:
the user-selection by the first user within the facepile comprises selecting a user-selectable option to start communicating with the plurality of second users associated with all of the visual indications displayed in the facepile; and
the communications composer provides communication between the first user and the plurality of second users associated with all of the visual indications displayed in the facepile.

7. The method of claim 1, wherein the communication provided by the communications composer comprises one of:
an instant message (IM) session;
an e-mail; or
a Short Message Service (SMS) message.

8. One or more computer-readable non-transitory storage media in one or more computing systems, the media embodying logic that is operable when executed to:
determine, by querying a social graph of a social-networking system, a plurality of second users having a connection to a first user, the social graph comprising a plurality of nodes and edges connecting the nodes, the nodes comprising user nodes that are each associated with a particular user of the social-networking system;
provide a facepile for display on a display device of the first user, the facepile comprising a plurality of visual indications of the plurality of second users having a connection to the first user, each visual indication associated with one of the plurality of second users; and
provide a communications composer for display on the display device in response to a user-selection by the first user within the facepile, the communications composer comprising a user interface operable to provide communication between the first user and the plurality of second users associated with the visual indications displayed in the facepile.

9. The media of claim 8, wherein the communications composer comprises an address field that is pre-populated with the plurality of second users associated with the visual indications displayed in the facepile.

10. The media of claim 8, wherein the communications composer comprises a message field that is pre-populated with text relating to content associated with the facepile.

11. The media of claim 8, wherein determining, by querying the social graph of the social-networking system, the plurality of second users having a connection to the first user comprises:
ranking, with respect to the first user, one or more nodes of the social graph; and
selecting a plurality of nodes of the social graph based at least in part on the ranking.

12. The media of claim 8, wherein:
each visual indication of the facepile is selectable by the first user;
the user-selection by the first user within the facepile comprises a selection by the first user of one or more of the visual indications in the facepile; and
the communications composer provides communication between the first user and the plurality of second users associated with the selected visual indications of the facepile.

13. The media of claim 8, wherein:
the user-selection by the first user within the facepile comprises selecting a user-selectable option to start communicating with the plurality of second users associated with all of the visual indications displayed in the facepile; and
the communications composer provides communication between the first user and the plurality of second users associated with all of the visual indications displayed in the facepile.

14. The media of claim 8, wherein the communication provided by the communications composer comprises one of:
an instant message (IM) session;
an e-mail; or
a Short Message Service (SMS) message.

15. A system comprising:
one or more processors; and
a memory coupled to the one or more processors comprising instructions executable by the processors, the one or more processors being operable when executing the instructions to:
determine, by querying a social graph of a social-networking system, a plurality of second users having a connection to a first user, the social graph comprising a plurality of nodes and edges connecting the nodes, the nodes comprising user nodes that are each associated with a particular user of the social-networking system;
provide a facepile for display on a display device of the first user, the facepile comprising a plurality of visual indications of the plurality of second users having a connection to the first user, each visual indication associated with one of the plurality of second users; and
provide a communications composer for display on the display device in response to a user-selection by the first user within the facepile, the communications composer comprising a user interface operable to provide communication between the first user and the plurality of second users associated with the visual indications displayed in the facepile.

16. The system of claim 15, wherein the communications composer comprises an address field that is pre-populated with the plurality of second users associated with the visual indications displayed in the facepile.

17. The system of claim 15, wherein the communications composer comprises a message field that is pre-populated with text relating to content associated with the facepile.

18. The system of claim 15, wherein the communication provided by the communications composer comprises one of:
an instant message (IM) session;
an e-mail; or
a Short Message Service (SMS) message.

19. The system of claim 15, wherein:
each visual indication of the facepile is selectable by the first user;
the user-selection by the first user within the facepile comprises a selection by the first user of one or more of the visual indications in the facepile; and
the communications composer provides communication between the first user and the plurality of second users associated with the selected visual indications of the facepile.

20. The system of claim 15, wherein:
the user-selection by the first user within the facepile comprises selecting a user-selectable option to start communicating with the plurality of second users associated with all of the visual indications displayed in the facepile; and
the communications composer provides communication between the first user and the plurality of second users associated with all of the visual indications displayed in the facepile.
